(19) United States
(12) Patent Application Publication
(10) Pub. No.: US 2016/0251211 A1
(43) Pub. Date: Sep. 1, 2016

(54) PRESSURE REGULATION IN BEVERAGE CONTAINERS

(71) Applicant: Drinktanks Corporation, Bend, OR (US)

(72) Inventors: Nicholas Hill, Bend, OR (US); John Herrick, Sunriver, OR (US)

(21) Appl. No.: 15/132,577

(22) Filed: Apr. 19, 2016

Related U.S. Application Data
(63) Continuation of application No. 15/047,186, filed on Feb. 18, 2016.
(60) Provisional application No. 62/121,403, filed on Feb. 26, 2015.

(51) Int. Cl. B67D 1/12; B67D 1/04; B67D 1/08; B67D 1/00

(52) U.S. Cl. CPC B67D 1/1252; B67D 1/0004; B67D 1/0406; B67D 1/0801; B67D 2001/0822

(57) ABSTRACT

Pressure regulating systems for beverage containers are disclosed that include a gas pressure regulator integrally joined to a lid or cover for a beverage container. In some implementations a dispensing device is also integrated into the lid.

### CROSS-REFERENCE TO RELATED APPLICATIONS

This application is a continuation application of U.S. patent application Ser. No. 15/047,186, filed Feb. 18, 2016, which claims priority to U.S. Provisional Application Ser. No. 62/121,403, filed Feb. 26, 2015, the entire disclosures of which are incorporated herein by reference.

### BACKGROUND

Pressurized beverage containers (containers that are capable of maintaining internal pressure, e.g., from carbonation or compressed gas) are typically of single use design, e.g. a can or bottle of beer. These containers are generally constructed of glass or an aluminum alloy. Closure mechanisms range from caps, twist off or pressed, to tabs which are integrally formed with the lid or top of the vessel.

Compressed gases such as carbon dioxide (CO₂) and Nitrogen are used for both the pressurization of beverages in containers as well as providing carbonation in solution in the beverage. In the case of many carbonated liquids it is beneficial to be able to control or meter the amount of pressure of the gas being used.

Some larger containers for carbonated beverages, e.g. kegs, while reusable, and in some cases pressurizable, are not easily transportable or easily cleaned due to their large size and valve/dispensing system. Medium sized (e.g., 32 or 64 ounce) beer containers, commonly known as “growlers,” are generally not capable of maintaining carbonation or pressurization, and thus if the entire contents are not consumed at one sitting the remaining beer will go flat. Recently, efforts have been made to provide growler-sized beverage containers that are configured to allow a user to inject a gas into the container to prevent the beverage from going flat.

### SUMMARY

The technology disclosed herein relates to systems for regulating gas pressure in a beverage container.

In one aspect, the invention features a device comprising a lid for a beverage container, and a compressed gas pressure regulator integrated into the lid.

Some implementations include one or more of the following features.

In some implementations the lid may be threaded. The compressed gas pressure regulator may include a regulator housing integrally formed with the lid. The housing may include an internal bore configured to contain valve components of the compressed gas pressure regulator, for example a spring biased piston. The compressed gas pressure regulator may include a pressure adjustment element configured to allow a user to adjust the pressure within the container from outside of the container. In some cases, the pressure adjustment element comprises a threaded knob configured to apply adjustable compression to a piston spring, in which case the housing may include a threaded bore configured to receive the threaded knob.

The compressed gas pressure regulator may also include a pressure display that is visible from the exterior of the beverage container. The gas pressure regulator may be configured to reduce gas pressure from a source pressure of at least 800 psi to a pressure of less than 100 psi, in some cases to a gas pressure of less than 20 psi or even less than 10 psi. The compressed gas pressure regulator may be configured to allow air or other gas to be purged from within a container on which the lid is mounted. In some cases, the lid includes a pressure relief valve. The lid may include an inlet through which a gas can be injected into the container, in fluid communication with the gas pressure regulator.

The invention also features methods of using the devices disclosed herein.

### DESCRIPTION OF THE DRAWINGS

FIG. 1 is a perspective view of a pressure regulation system according to one implementation.

FIG. 2 is an enlarged perspective view of the pressure regulation system shown in FIG. 1.

FIG. 3 is a cross-sectional view taken along the long axis of the gas pressure regulator portion of the system shown in FIG. 1.

FIG. 4 is an enlarged perspective view showing details of the purge valve assembly.

FIG. 5 is a perspective view taken from below the lid showing components of the purge valve assembly.

FIG. 6 is a perspective view of an example of a container on which the pressure regulating systems described herein may be used.

FIG. 7 is a perspective view of a pressure regulation system according to an alternate implementation, in which pressure regulation components similar to those shown in FIG. 1 are integrated into a handle for a container.

FIG. 7A is a cross-sectional view of the handle of FIG. 7 mounted on a vessel.

FIG. 7B is a side cross-sectional view and FIG. 7C is a top cross-sectional view of the handle shown in FIG. 7.

### DETAILED DESCRIPTION

Pressure regulation systems are described herein that provide gas pressure regulation and metering to establish and maintain a desired pressure within a beverage container such as a growler or other portable multi-serving container. These systems include a gas pressure regulator integrated into a lid or cap that is placed on the container to seal the container. In some implementations, the pressure regulation system provides automatic regulation of gas pressure to a preset level. In addition, the pressure regulation system may provide for purging trapped air or other gases from the container and allowing them to be replaced with the desired compressed gas.

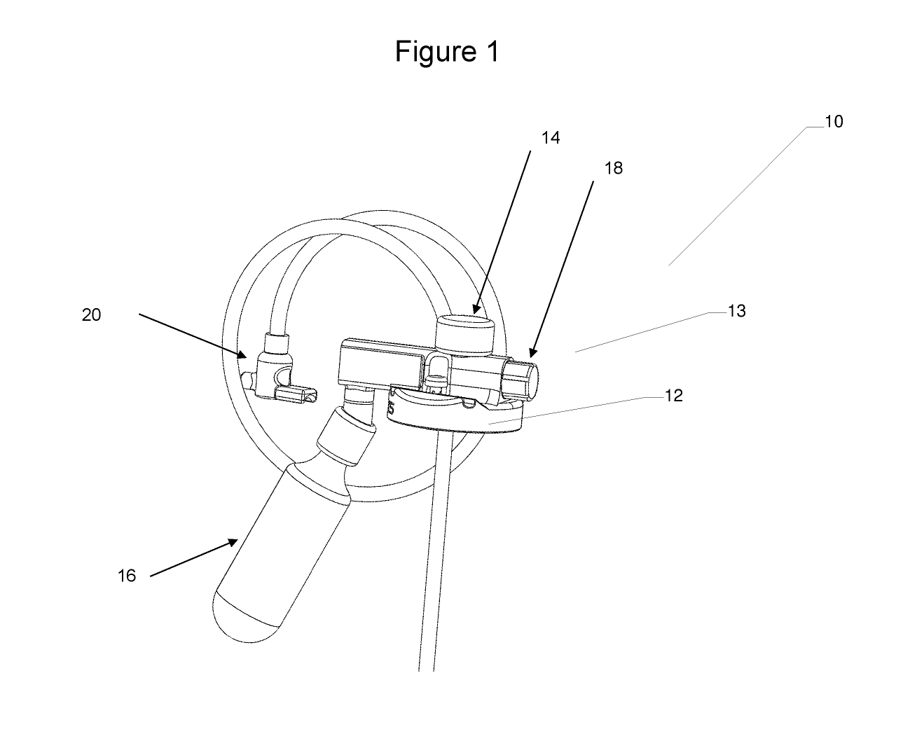

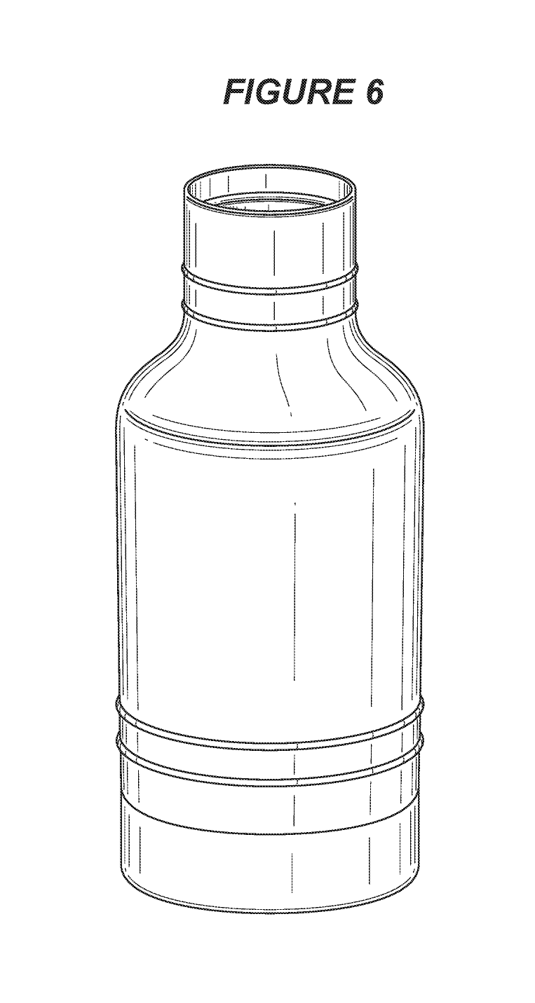

One possible configuration of a pressure regulating system 10 is shown in FIG. 1. The system includes a lid 12 that is configured to be sealingly mounted on a beverage container (e.g., as shown in FIG. 6). Examples of suitable lids and sealing arrangements include, but are not limited to, those described in U.S. Pat. No. 8,887,959, the full disclosure of which is incorporated herein by reference. Suitable containers include double walled metal vessels and other types of containers used for beverage storage.

A gas pressure regulator 13, described in further detail below, is integrally joined to or integrally formed with the lid 12. The gas pressure regulator includes a visible pressure display 14 that is connected to a regulated pressure supply e.g., an external compressed gas source 16. The external compressed gas source provides a supply of high pressure gas and may be a typical pressurized cartridge (e.g., Nitrogen or CO₂ cartridge), as shown, or a larger stationary supply. The display 14 may take the form of a gauge or other device for indicating the regulated pressure value to a user. The external pressure adjustment element 18 allows the user to adjust the regulated pressure to a desired value. Rotation of this component will vary the regulated pressure. The adjustment element 18 may be provided in a different form, for example, as a lever or button.

The pressure regulating system may also include a dispensing device 20, e.g., as described in U.S. Pat. No. 8,887,959, incorporated above. The dispensing device is also integrated into lid 12, and is configured to allow fluids to be dispensed from the container. The tubing of the dispensing device may be flexible, as shown, or rigid and may have a variety of control valves configured to control flow of liquid from the container. These control valves may be actuated in any desired manner, e.g., by a push button, rotating member or the like. In some cases, the dispensing device 20 will be omitted, e.g., if the beverage container includes a dispensing device that is not integrated with the lid, e.g., a spigot positioned elsewhere on the container.

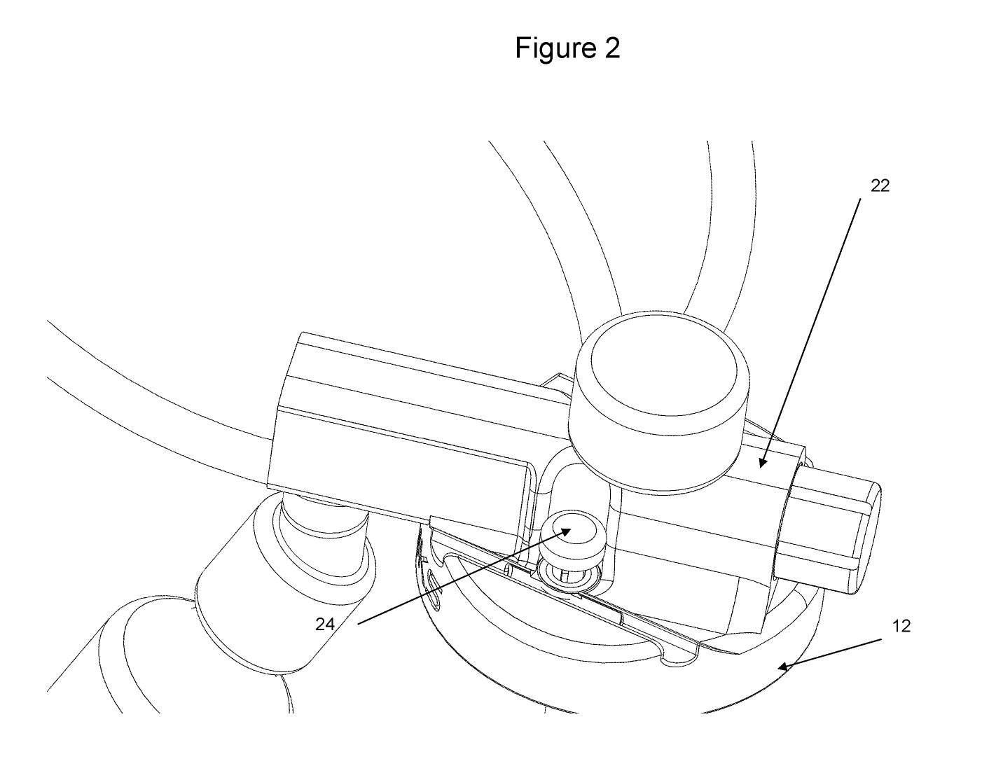

Referring to FIG. 2, the gas pressure regulator 13 includes a regulator housing 22, which may be, for example, a molded polymer component, a cast metal component or a product of machining. This housing holds all of the key pressure regulation components, discussed below. The lid/cap 12 is preferably integrally formed, e.g., molded, with the housing 22. Integrating the regulator housing with the lid/cap allows for minimization of parts as well as refined structural integrity. Moreover, having the pressure regulator integrated into the lid makes it easy for a user to regulate the pressure within the container and use the pressure regulating system 10 on different containers.

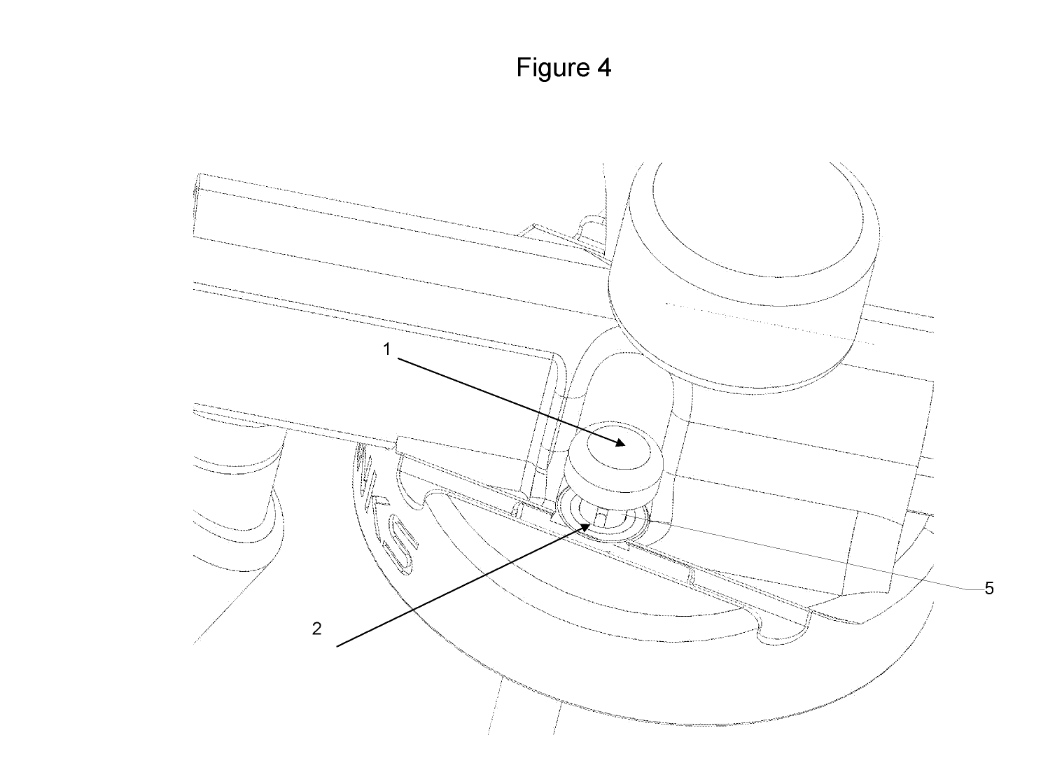

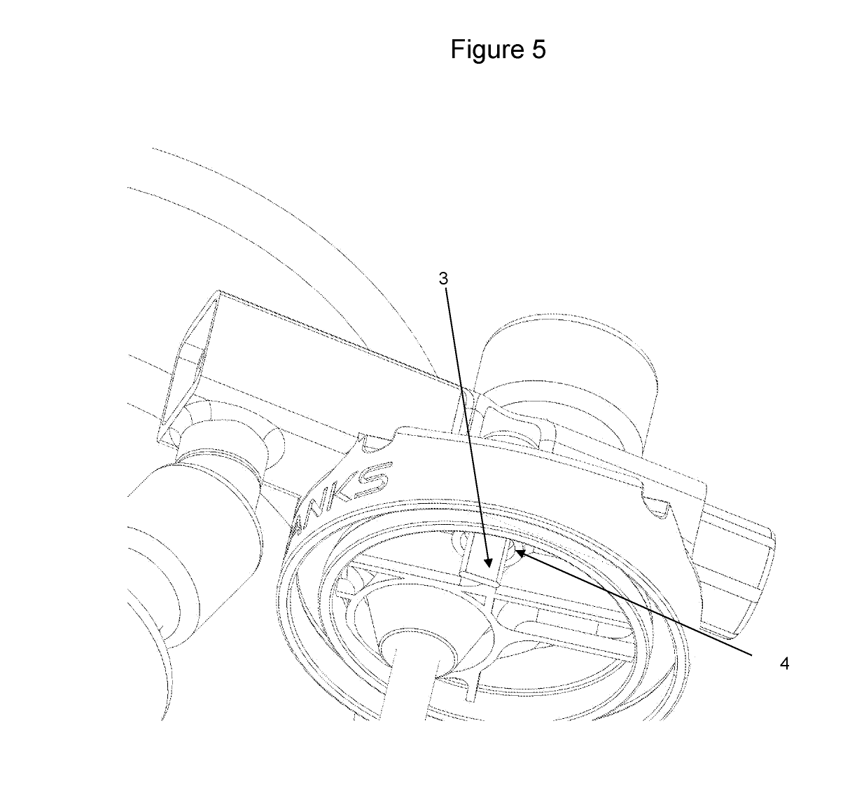

A manually operated purge valve assembly 24 allows the vessel to be evacuated of air and then refilled with a gas such as CO₂ or Nitrogen, thus preserving the integrity of the beverage. This is especially important with fermented liquids such as beer for which extended contact with ambient air causes degradation of the beer. FIGS. 4 and 5 show further detail of the purge valve assembly, which includes an actuation button 1. Referring to FIG. 4, actuation button 1 may be depressed to allow the contents of the container to escape through grooves 2 in a valve shaft 5. Valve shaft 5 penetrates the lid so that it is in fluid communication with the container. Referring to FIG. 5, the valve assembly also includes a valve seat/seal 4 and a valve installation feature 3. As the purge valve button 1 is depressed, it pushes the valve seat 4 to the open position thus allowing the container to be exposed to ambient conditions. Leaving this valve open while injecting the desired compressed gas provides a means for less desired gasses to be expelled from the container and be replaced by the injected gas. Upon releasing the purge valve button 1 a spring (not shown) returns the valve seat 4 to its closed position.

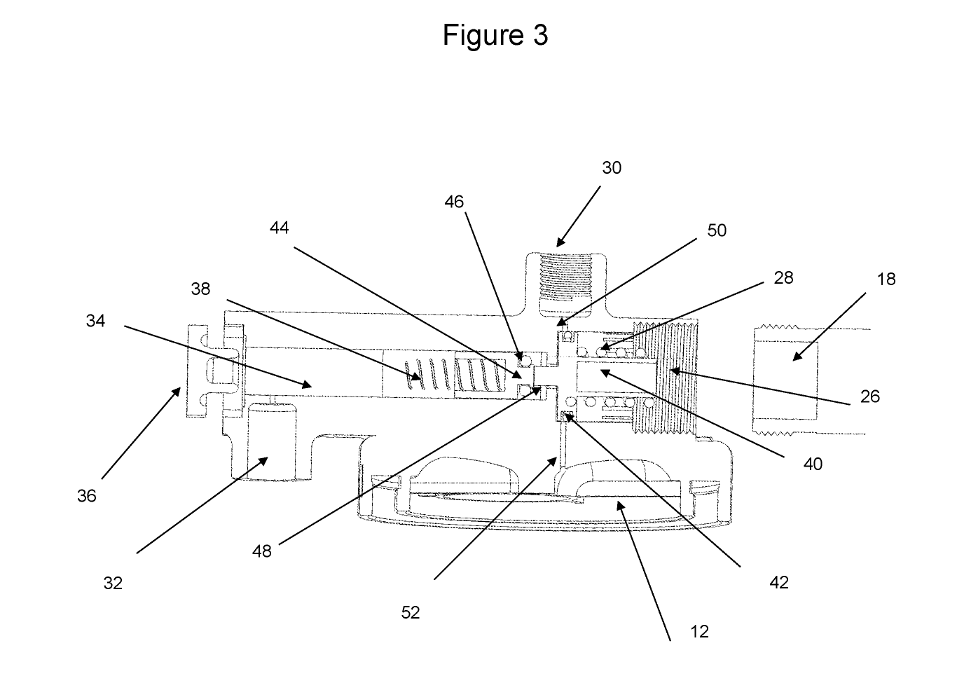

FIG. 3 shows the internal operating components of the gas pressure regulator. The external pressure adjustment element 18 is threaded into and out of a threaded receiving opening 26 in the housing in order to increase or decrease the amount of compression on a regulator piston spring 28. A pressure display outlet 30 is a source of regulated lower pressure gas and thereby provides a port to connect a display, e.g., the display 14 shown in FIG. 1, that will indicate the predetermined regulated outlet pressure set by adjusting the pressure adjustment element 18.

The gas inlet 32 provides a connection point for a high pressure gas source, e.g., source 16 shown in FIG. 1. This high pressure gas is channeled into a high pressure region conduit 34 which is formed integrally with the lid. An end cap 36 seals the conduit 34 and provides fixed compression for gas valve spring 38, which biases piston 40 towards O-ring 46.

To further describe FIG. 3, regulator piston spring 28 is positioned against piston 40. As external pressure adjustment element 18 is threaded into and out of the threaded receiving opening 26 in the housing, during adjustment by the user, the adjustment element 18 increases or decreases the compression on spring 28, which in turn imparts a force to piston 40. O-ring 42 on piston 40 seals against the outer wall of the piston bore. The force imparted on piston 40 by spring 28 regulates the high pressure gas to a lower pressure. Gases at this regulated pressure may escape through gas passage 50 and gas passage 52. Passage 50 provides a channel for the regulated gas to enter a pressure display device (e.g., display 14, FIG. 1) while passage 52 allows the regulated gas to enter the container for the purpose of carbonating the contents and/or pressurizing the container.

Valve 44, under load from spring 38, serves to close off the exit of high pressure gas from the high pressure region and is sealed when closed by O-ring 46. As the spring force on piston 40 increases, it will eventually reach a point at which it forces valve 44 away from wall 48 thus allowing high pressure gas to escape the high pressure region.

In some implementations, the compressed gas pressure regulator is configured to reduce gas pressures from 800 psi (source pressure) to a desired predetermined container pressure, e.g., less than 100 psi, less than 50 psi, less than 20 psi or even as low as 10 psi or less.

Other embodiments are within the scope of the following claims.

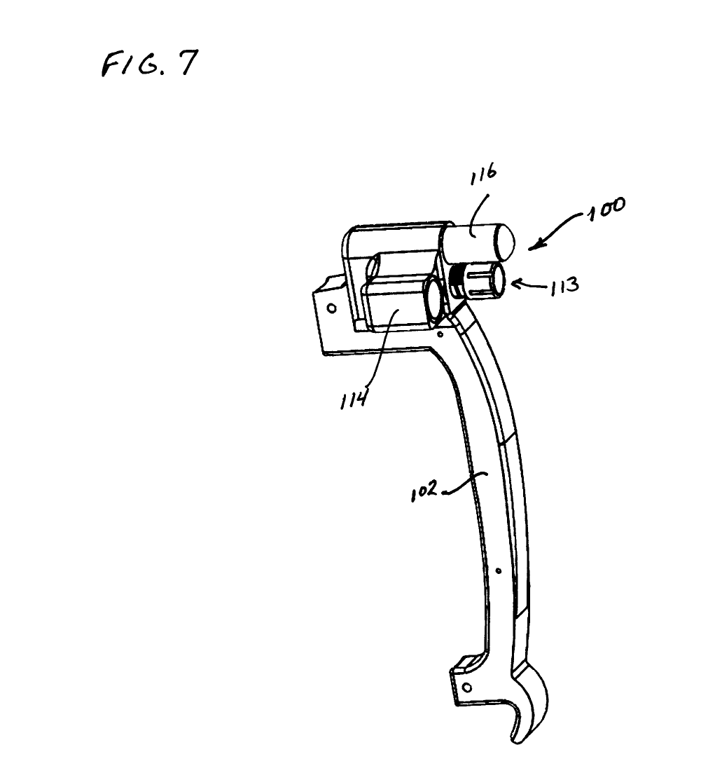

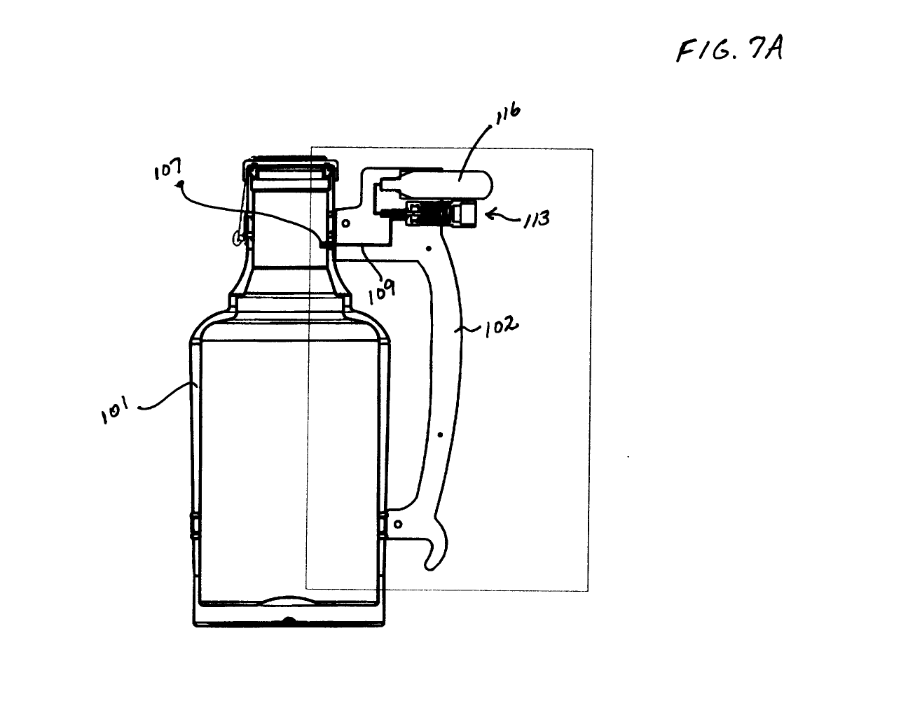

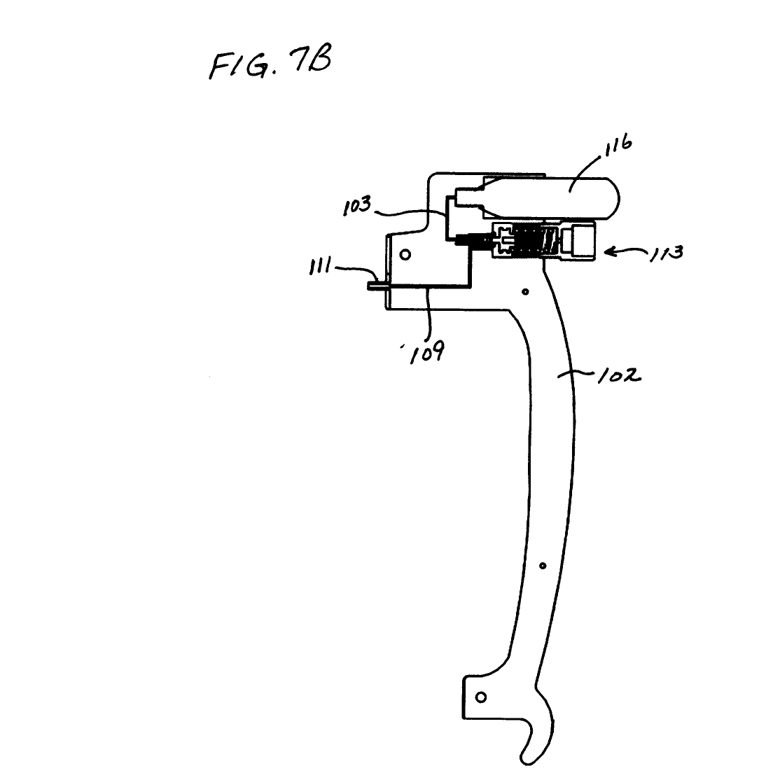

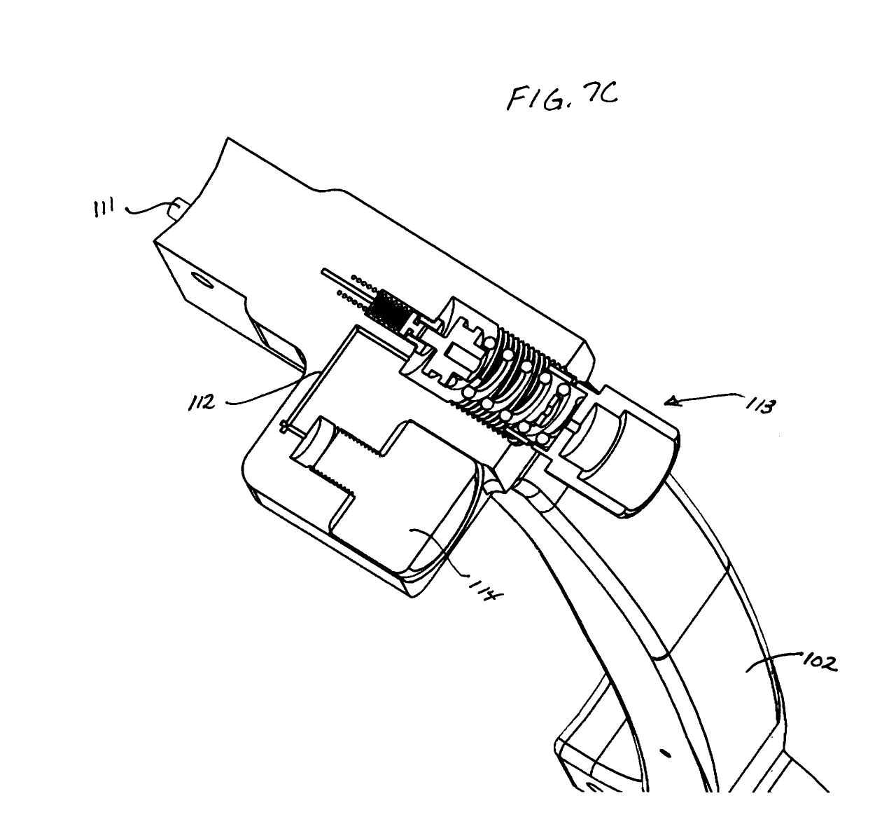

For example, while the pressure regulation system has been described above as being integrated into the lid of a vessel, the system can be associated with other parts of the vessel or otherwise mounted on the vessel. As an example, the pressure regulation system may be integrated into a handle for the vessel, e.g., as shown in FIGS. 7-7B.

Referring to FIGS. 7-7C, pressure regulation system 100 is mounted on a handle 102, and includes a gas pressure regulator 113 and a pressure display 114, having the same structures as gas pressure regulator 13 and display 14 described above. The pressure regulation system also includes a pressurized gas source 116.

As shown in FIG. 7A, the handle is mounted on a vessel 101. Vessel 101 has an inlet port 107 in fluid communication with an outlet port 109 of the handle via a fitting 111 (FIG. 7B) that extends from the handle and is received into the port 107. The handle 102 includes a high pressure conduit 103 connecting the gas source 116 and the pressure regulator 113, and a pressure conduit 105 delivering gas from the pressure regulator to the outlet 107. A further conduit 112, shown in FIG. 7C, connects the pressure regulator 113 and display 114.

What is claimed is:

1. A device comprising:
a lid for a beverage container; and
a compressed gas pressure regulator integrated into the lid.

2. The device of claim 1 wherein the compressed gas pressure regulator comprises a regulator housing integrally formed with the lid.

3. The device of claim 1 wherein the lid is threaded.

4. The device of claim 2 wherein the housing includes an internal bore configured to contain valve components of the compressed gas pressure regulator.

5. The device of claim 4 wherein the valve components include a spring biased piston.

6. The device claim 5 wherein the compressed gas pressure regulator includes a pressure adjustment element configured to allow a user to adjust the pressure within the container from outside of the container.

7. The device of claim 6 wherein the pressure adjustment element comprises a threaded knob configured to apply adjustable compression to a piston spring.

8. The device of claim 7 wherein the housing includes a threaded bore configured to receive the threaded knob.

9. The device of claim 1 wherein the compressed gas pressure regulator includes a pressure display that is visible from the exterior of the beverage container.

10. The device of claim 9 wherein the pressure display is mounted on the lid.

11. The device of claim 1 wherein the gas pressure regulator is configured to reduce gas pressure from a source pressure of at least 800 psi to a pressure of less than 100 psi.

12. The device of claim 1 further comprising a purge valve assembly configured to allow air or other gas to be purged from within a container on which the lid is mounted.

13. The device of claim 12 wherein the purge valve assembly is manually operated.

14. The device of claim 1 wherein the lid includes an inlet through which a gas can be injected into the container.

15. The device of claim 14 wherein the inlet is in fluid communication with the compressed gas pressure regulator.

16. The device of claim 14 wherein the inlet is accessible from the exterior of the container.

17. The device of claim 14 wherein the inlet is in fluid communication with a conduit that extends integrally from the lid.

18. A method of regulating gas pressure within a beverage container, the method comprising:
providing the container with a lid having an integral compressed gas pressure regulator; and
adjusting the pressure within the container using the compressed gas pressure regulator.

19. The method of claim 18 further comprising regulating the pressure of gas from an external source down to a desired container pressure using the gas pressure regulator.

20. The method of claim 18 further comprising purging air or other gas from the container using a purge valve assembly.

21. The method of claim 20 wherein purging comprises actuating a gas purge valve to allow gas to escape the container and delivering a purge gas to the container.

22. The method of claim 18 wherein adjusting comprises using an actuator to adjust the degree of compression of a piston spring within the compressed gas pressure regulator.

23. The method of claim 22 wherein using the actuator comprises turning a threaded knob.

24. The method of claim 18, further comprising injecting a gas into the container from an external source of compressed gas.

25. The method of claim 24, wherein the source comprises a compressed gas cartridge.

26. A device comprising:
a beverage container vessel; and
in fluid communication with the vessel, a pressure regulation system comprising:
a compressed gas pressure regulator, and
a port configured to receive a source of compressed gas, the port being in fluid communication with the gas pressure regulator.

27. The device of claim 26 further comprising a pressure display in fluid communication with the gas pressure regulator.

28. The device of claim 26 wherein the pressure regulation system is mounted on a handle disposed on a wall of the vessel.
